(19) United States
(12) Patent Application Publication
(10) Pub. No.: US 2015/0040742 A1
(43) Pub. Date: Feb. 12, 2015

(54) APPARATUS AND METHOD FOR MULTILAYERED MUSIC PLAYBACK BASED ON COMMANDS AND ATTRIBUTES

(71) Applicant: Beamz Interactive, Inc., Scottsdale, AZ (US)

(72) Inventors: Bardia Dejban, Calabasas, CA (US); Shannon Dejban, Calabasas, CA (US); Gary Bencar, Holualoa, HI (US); Dave Sandler, Saint James, NY (US); Charles Mollo, Scottsdale, AZ (US)

(73) Assignee: Beamz Interactive, Inc., Scottsdale, AZ (US)

(21) Appl. No.: 14/165,449

(22) Filed: Jan. 27, 2014

Related U.S. Application Data
(63) Continuation-in-part of application No. 14/088,178, filed on Nov. 22, 2013.
(60) Provisional application No. 61/863,824, filed on Aug. 8, 2013.

(51) Int. Cl. G10H 1/00

(52) U.S. Cl. CPC G10H 1/0008; G10H 2210/161; G10H 2220/005
USPC 84/609

(57) ABSTRACT

Method and apparatus of a device for playback of a multilayered media file is provided. The method comprises receiving one or more attributes of a musical program of a multilayered media file comprising a plurality of musical programs. The method also comprises receiving a command related to the musical program of the multilayered media file. The method also comprises outputting the multilayered media file based on the attributes and the command.

### CROSS-REFERENCE TO RELATED APPLICATION(S) AND CLAIM OF PRIORITY

The present application is a continuation in part of U.S. patent application Ser. No. 14/088,178, filed Nov. 22, 2013, entitled “APPARATUS AND METHOD FOR MULTILAYERED MUSIC PLAYBACK”. The present application claims priority to U.S. Provisional Patent Application Ser. No. 61/863,824, filed Aug. 8, 2013, entitled “APPARATUS AND METHOD FOR LAYERED MUSIC PLAYBACK”; the content of the above-identified patent document is incorporated herein by reference.

### TECHNICAL FIELD

The present application relates generally to playing media, more specifically, to multilayered media.

### BACKGROUND

Music includes several layers, such as vocals, guitar, drums, etc. Each layer can have a unique sound and may share a similar tempo and pace. Combined, the layers of music form a musical composition.

Playback applications allow digital devices to play music and videos. Playback applications generally play entire compositions that include several layers of music. As playback applications grow more complex, there is a need for controlling the playback of individual layers of music.

### SUMMARY

A method of operating a device for playback of a multilayered media file is provided. The method comprises receiving one or more attributes of a musical program of a multilayered media file comprising a plurality of musical programs. The method also comprises receiving a command related to the musical program of the multilayered media file. The method also comprises outputting the multilayered media file based on the attributes and the command.

An apparatus configured for playback of a multilayered media file is provided. The apparatus comprises a speaker, a display; and one or more processors. The one or more processors are configured to receive one or more attributes of a musical program of a multilayered media file comprising a plurality of musical programs, receive a command related to the musical program of the multilayered media file, and cause the speaker and the display to output the multilayered media file based on the attributes and the command.

A computer readable medium configured to store program instructions for playback of a multilayered media file is provided. The program instructions are configured to cause one or more processors to receive one or more attributes of a musical program of a multilayered media file comprising a plurality of musical programs, receive a command related to the musical program of the multilayered media file, and cause the speaker and the display to output the multilayered media file based on the attributes and the command.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example electronic device according to embodiments of the present disclosure;

FIG. 2 illustrates a diagram of a system for layered music playback in accordance with embodiments of the present disclosure;

FIG. 3 illustrates a definition file that defines a multilayered media file in accordance with embodiments of the present disclosure;

FIG. 4 illustrates a portion of a definition file that defines a multilayered media file in accordance with embodiments of the present disclosure;

FIG. 5 illustrates a graphical user interface (GUI) in accordance with embodiments of the present disclosure; and

FIG. 6 illustrates a flowchart for playback of multilayered media file 216 according to embodiments of the present disclosure.

### DETAILED DESCRIPTION

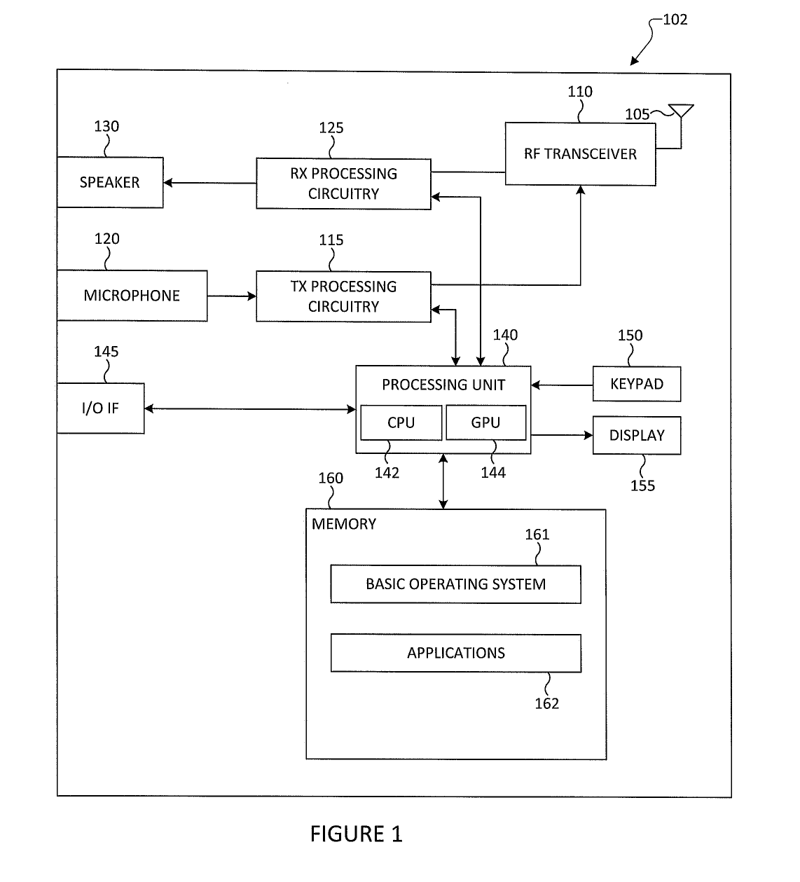

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

FIG. 1 illustrates an example electronic device 102 according to embodiments of the present disclosure. The embodiment of the electronic device 102 shown in FIG. 1 is for illustration only. Other embodiments of an electronic device could be used without departing from the scope of this disclosure.

The electronic device 102 can be a standalone device and includes an antenna 105, a radio frequency (RF) transceiver 110, transmit (TX) processing circuitry 115, a microphone 120, and receive (RX) processing circuitry 125. The electronic device 102 also includes a speaker 130, a processing unit 140, an input/output (I/O) interface (IF) 145, a keypad 150, a display 155, and a memory 160. The electronic device 102 could include any number of each of these components.

The processing unit 140 includes processing circuitry configured to execute instructions, such as instructions stored in the memory 160 or internally within the processing unit 140. The memory 160 includes a basic operating system (OS) program 161 and one or more applications 162. The electronic device 102 could represent any suitable device. In particular embodiments, the electronic device 102 represents a mobile telephone, smartphone, personal digital assistant, tablet computer, a touchscreen computer, and the like. The electronic device 102 plays multilayered media.

The RF transceiver 110 receives, from the antenna 105, an incoming RF signal transmitted by a base station or other device in a wireless network. The RF transceiver 110 down-converts the incoming RF signal to produce an intermediate frequency (IF) or baseband signal. The IF or baseband signal is sent to the RX processing circuitry 125, which produces a processed baseband signal (such as by filtering, decoding, and/or digitizing the baseband or IF signal). The RX processing circuitry 125 can provide the processed baseband signal to the speaker 130 (for voice data) or to the processing unit 140 for further processing (such as for web browsing or other data). The RF transceiver can include one or more of a Bluetooth transceiver, a Wifi transceiver, and an infrared (IR) transceiver, and so on; and limitation to the type of transceiver is not to be inferred.

The TX processing circuitry 115 receives analog or digital voice data from the microphone 120 or other outgoing baseband data (such as web data, e-mail, or interactive video game data) from the processing unit 140. The TX processing circuitry 115 encodes, multiplexes, and/or digitizes the outgoing baseband data to produce a processed baseband or IF signal. The RF transceiver 110 receives the outgoing processed baseband or IF signal from the TX processing circuitry 115 and up-converts the baseband or IF signal to an RF signal that is transmitted via the antenna 105.

In some embodiments, the processing unit 140 includes one or more processors, such as central processing unit (CPU) 142 and graphics processing unit (GPU) 144, embodied in one or more discrete devices. In some embodiments, the CPU 142 and the GPU 144 are implemented as one or more integrated circuits disposed on one or more printed circuit boards. The memory 160 is coupled to the processing unit 140. In some embodiments, part of the memory 160 represents a random access memory (RAM), and another part of the memory 160 represents a Flash memory acting as a read-only memory (ROM).

In some embodiments, the memory 160 is a computer readable medium that stores program instructions to play multilayered media. When the program instructions are executed by the processing unit 140, the program instructions cause one or more of the processing unit 140, CPU 142, and GPU 144 to execute various functions and programs in accordance with embodiments of this disclosure.

The processing unit 140 executes the basic OS program 161 stored in the memory 160 in order to control the overall operation of electronic device 102. For example, the processing unit 140 can control the RF transceiver 110, RX processing circuitry 125, and TX processing circuitry 115 in accordance with well-known principles to control the reception of forward channel signals and the transmission of reverse channel signals.

The processing unit 140 is also capable of executing other processes and programs resident in the memory 160, such as operations for playing multilayered media as described in more detail below. The processing unit 140 can also move data into or out of the memory 160 as required by an executing process. In some embodiments, the processing unit 140 is configured to execute a plurality of applications 162. The processing unit 140 can operate the applications 162 based on the OS program 161 or in response to a signal received from a base station. The processing unit 140 is coupled to the I/O interface 145, which provides electronic device 102 with the ability to connect to other devices, such as laptop computers, handheld computers, and server computers. The I/O interface 145 is the communication path between these accessories and the processing unit 140.

The processing unit 140 is also optionally coupled to the keypad 150 and the display unit 155. An operator of electronic device 102 uses the keypad 150 to enter data into electronic device 102. The display 155 may be a liquid crystal display, light emitting diode (LED) display, or other display capable of rendering text and/or at least limited graphics from web sites. Display unit 155 may be a touchscreen which displays keypad 150. Alternate embodiments may use other types of input/output devices and displays.

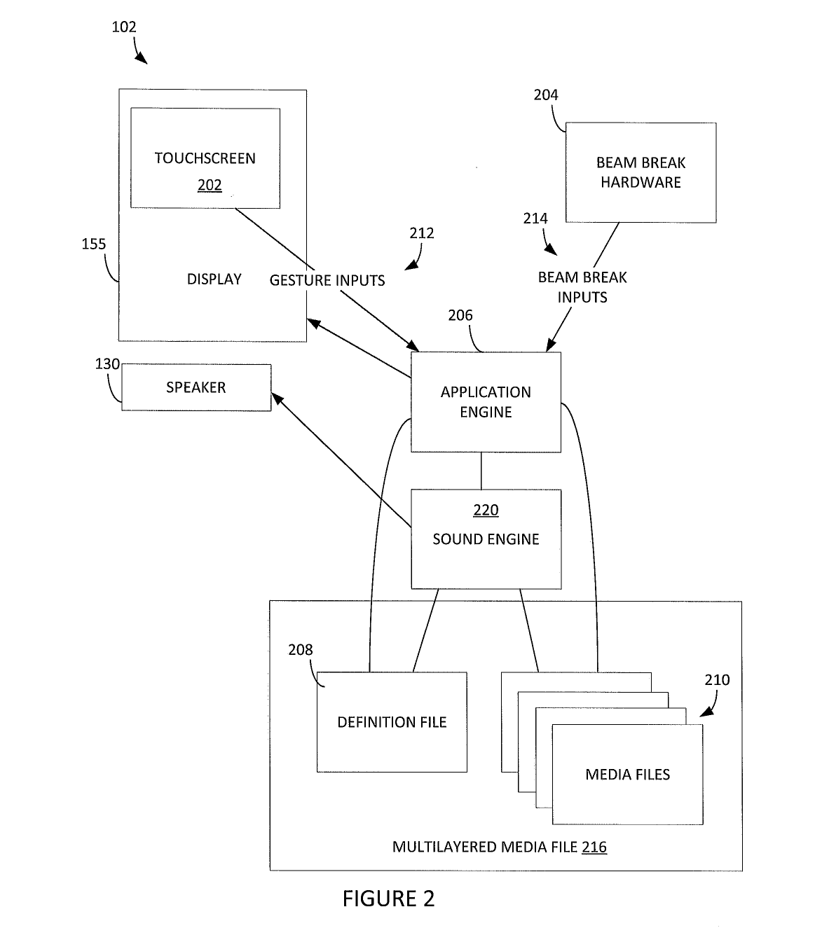

FIG. 2 illustrates a diagram of a system for layered music playback in accordance with embodiments of the present disclosure. The system of FIG. 2 can be implemented in electronic device 102 and embodied as one of a computer, a smart phone, a tablet, a touchscreen computer, and the like. Application engine 206 receives one or more of gesture inputs 212 from touchscreen 202 of display unit 155, and may also receive beam break inputs 214 from beam break hardware 204. Application engine 206 controls playback of media files 210 that are combined to form multilayered media file 216 based on one or more of gesture inputs 212, beam break inputs 214, and definition file 208 via sound engine 220. In certain embodiments, beam break hardware 204 and its associated functions are included as a part of electronic device 102 or one or more components of electronic device 102 and their associated functions are included as part of beam break hardware 204.

Gesture inputs 212 include one or more touch gestures that indicate when and how touchscreen 202 is being touched. Gesture inputs 212 include a tap gesture, a long press gesture, and a drag gesture. With a tap gesture or a long press gesture, a touch starts and ends at substantially the same point on touchscreen 202 on display 155 of electronic device 102. With a tap gesture, the touch is held at substantially the same point on touch screen x302 on display 155 for a substantially short period of time, such as with a threshold for the short period of time of 0.5 seconds or less. With a long press gesture, the touch is held at substantially the same point on touch screen x302 on display 155 for a longer period of time, such as with a threshold for the longer period of time of 0.5 seconds or more. Additional thresholds may be used for a long press gesture with each threshold associated with a different action to be taken by the application 162. With a drag gesture, the touch is at least partially moved while it is being held on touchscreen 202 of display 155 of electronic device 202 and is held until the touch is released.

Output from application engine 206 is displayed on the display 155 and output from sound engine 220 is played on speaker 130. The combination of application engine 206 and 220 form an application, such as application 162. Display 155 comprises touchscreen 202. When displayed, output from application engine 206 can be shown to simulate beam break hardware 204 on display 155.

Multilayered media file 216 comprises a plurality of music programs, such as media files 210, that each comprises one or more audio files and video files. Multilayered media file 216 includes definition file 208. Each of the music programs comprises a subset of a predetermined musical composition, shown in FIG. 2 as media files 210, which are also referred to as a layer of media. Each of the music programs or layers of media is correlated to each other and comprises sound elements configured to generate sympathetic musical sounds. A trigger can be associated with a musical program to control the timing and playback of the musical program. When multiple media files are played together, an entire song or composition that incorporates each of the layers of media files 210 can be heard and seen via display 155 and speaker 130. Application engine 206 and sound engine 220 control which media files 210 of multilayered media file 216 are played and when media files 210 are played based on gesture inputs 212, beam break inputs 214, and definition file 208. Certain media files 210 can lasts an entire length of the song, whereas other media files 210 may last for a shorter duration, and can be referred to as a one-shot.

Definition file 208 describes media files 210 and one or more beam layouts for application engine 206 and sound engine 220. Based on the information of definition file 18, application engine 206 and sound engine 220 determine specific timings for when media files 210 are played based on one or more of gesture inputs 212 and beam break inputs 214.

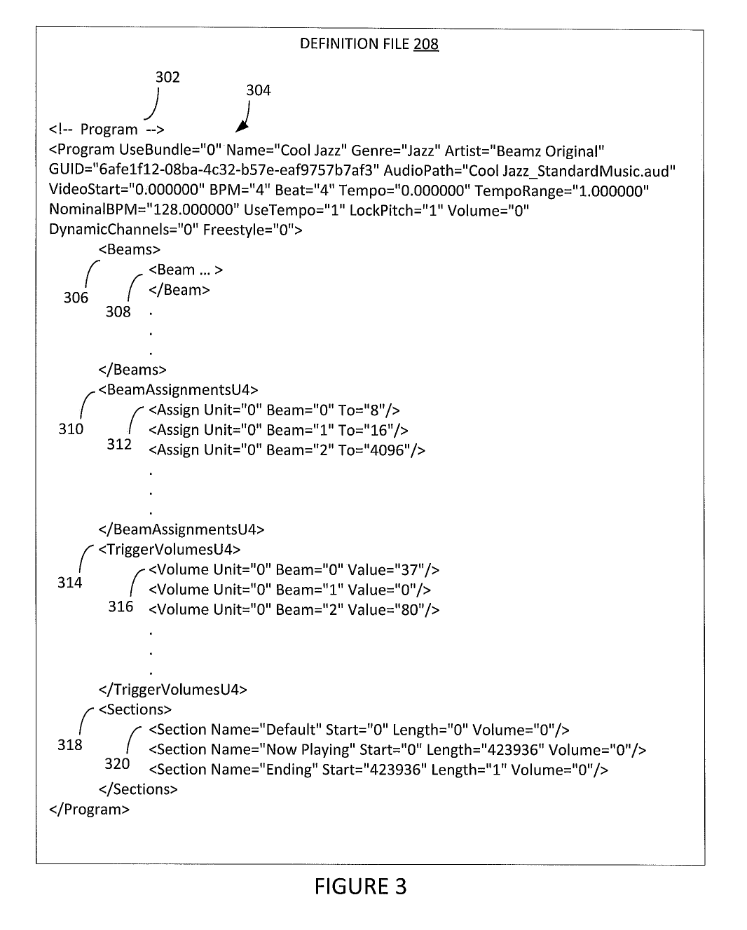

FIG. 3 illustrates a definition file that defines a multilayered media file in accordance with embodiments of the present disclosure. The embodiment shown in FIG. 3 is for illustration only. Other embodiments could be used without departing from the scope of this disclosure.

Definition file 208 is illustrated as an extensible markup language (XML) file comprising one or more elements described using one or more tags and attributes. An alternative file format can be used without departing from the scope of the present disclosure.

Definition file 208 includes comment 302, which states “<!-Program->”. Comment 302 indicates that the definition file includes a program.

Definition file 208 also includes “Program” element 304 comprising a plurality of attributes and additional elements. The attributes comprise name value pairs that multilayered media file 208. The attributes include:
“UseBundle=“0”” which indicates that bundles are not used with multilayered media file 216;
“Name=“Cool Jazz””, which indicates the name of the song of multilayered media file 216 is “Cool Jazz”;
“Genre=“Jazz””, which indicates the genre of the song of multilayered media file 216 is “Jazz”;
“Artist=“Beamz Original””, which indicates the artist of the song of multilayered media file 216 is “Beamz Original”;
“GUID=“6afe1f12-08ba-4c32-b57e-eaf9757b7af3″””, which indicates the globally unique identifier (GUID) of multilayered media file 216 is “6afe1f12-08ba-4c32-b57e-eaf9757b7af3”;
“AudioPath=“Cool Jazz_StandardMusic.aud””, which indicates the path to the files of multilayered media file 216 is “Cool Jazz_StandardMusic.aud”;
“VideoStart=“0.000000””, which indicates the video start of multilayered media file 216 is 0 seconds after the start of a video associated with multilayered media file 216;
“BPM=“4””, which indicates the beats per measure (BPM) of the song of multilayered media file 216 is 4 beats per measure;
“Beat=“4””, which indicates the beats of the song of multilayered media file 216 are quarter notes;
“Tempo=“0.000000””, which indicates the tempo of the song of multilayered media file 216 is adjusted by the value of “0”;
“TempoRange=“1.000000””, which indicates the range of the tempo of the song of multilayered media file 216 is “1”;
“NominalBPM=“128.000000””, which indicates the nominal beats per minute of the song of multilayered media file 216 is 128 beats per minute;
“UseTempo=“1””, which is a Boolean value that indicates the tempo of multilayered media file 216 is used for playback of multilayered media file 216;
“LockPitch=“1””, which is a Boolean value that indicates the pitch of multilayered media file 216 is locked;
“Volume=“0””, which indicates the volume of multilayered media file 216 is adjusted by a value of “0”;
“DynamicChannels=“0””, which is a Boolean value that indicates dynamic channels are not used by multilayered media file 216; and
“Freestyle=“0””, which is a Boolean value that indicates a freestyle option is not used by multilayered media file 216.

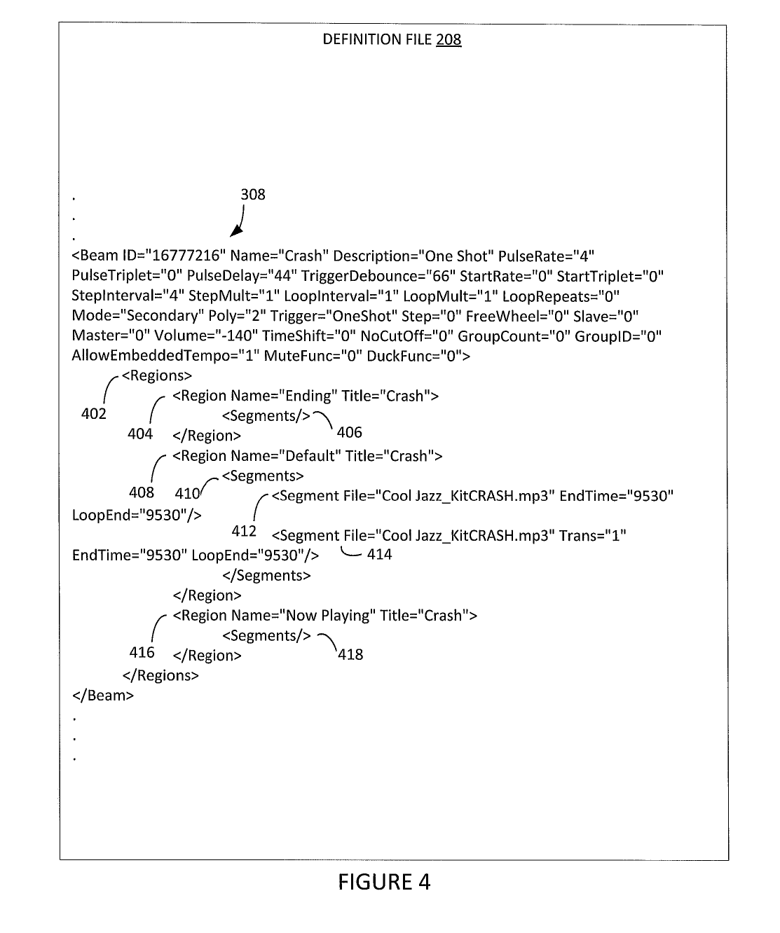

Program element 304 includes a “Beams” element 306. Beams element 306 includes one or more “Beam” elements 308, which is further described in FIG. 4.

Program element 304 includes a “BeamAssignmentsU4” element 310. BeamAssignmentsU4 element 310 includes one or more “Assign” elements 312. Assign element 312 includes attributes that define a beam assignment. The attributes of Assign element 312 include:
“Unit=“0””, which indicates a unit being assigned;
“Beam=“0””, which indicates a beam of the unit being assigned; and
“To=“16””, which indicates a value to which the beam of the unit is being assigned.

Program element 304 includes a “TriggerVolumesU4” element 314. TriggerVolumesU4 element 314 includes one or more “Volume” elements 316. Volume element 316 includes attributes that define volume of a beam relative to a master volume of multilayered media file 216. The attributes of Volume element 316 include:
“Unit=“0””, which indicates a unit being assigned;
“Beam=“0””, which indicates a beam of the unit being assigned; and
“To=“37””, which indicates an amount by which to adjust the volume of the beam of the unit.

Program element 304 includes a “Sections” element 318. Sections element 318 includes one or more “Section” elements 320. Section element 320 includes attributes that define sections of an audio file associated with a musical program or layer of multilayered media file 216. The attributes of Section element 320 include:
“Name=“Default””, which indicates a name of the section of multilayered media file 216;
“Start=“0””, which indicates a start of the section of multilayered media file 216;
“Length=“0””, which indicates a length of the section of multilayered media file 216; and

“Volume=“37””, which indicates an amount by which to adjust the volume of the section of multilayered media file 216.

FIG. 4 illustrates a portion of a definition file that defines a multilayered media file in accordance with embodiments of the present disclosure. The embodiment shown in FIG. 4 is for illustration only. Other embodiments could be used without departing from the scope of this disclosure.

Definition file 208 includes at least one “Beam” element 308 comprising a plurality of attributes and additional elements. The attributes comprise name value pairs that describe a beam or trigger of multilayered media file 208. The attributes include:
“ID=“16777216””, which indicates an identification number of Beam element 308;
“Name=“Crash””, which indicates a name of Beam element 308;
“Description=“One Shot””, which provides a text description of Beam element 308;
“PulseRate=“4””, which is a positive integer, the reciprocal of which indicates a pulse of a beam or trigger, the pulse of Beam element 308 indicated as being measured in quarter (¼) notes;
“PulseTriplet=“0””, which indicates Beam element 308 does not include a triplet pulse;
“PulseDelay=“44””, which indicates Beam element 308 is delayed by 44 pulses;
“TriggerDebounce=“66””, which indicates 66 pulses are used to allow a trigger associated with Beam element 308 to settle from bouncing between a triggered state and a non-triggered state;
“StartRate=“0””, which indicates a starting rate of Beam element 308 is adjusted by 0 pulses;
“StartTriplet=“0””, which indicates a starting triplet of Beam element 308 is adjusted by 0 pulses;
“StepInterval=“4””, which indicates a step interval of Beam element 308 comprises a value of 4;
“StepMult=“1””, which indicates a step multiplier of Beam element 308 comprises a value of 1;

“LoopInterval=“1””, which indicates a loop interval of Beam element 308 comprises a value of 1;
“LoopMult=“1””, which indicates a loop multiplier of Beam element 308 comprises a value of 1;
“LoopRepeats=“0””, which indicates a number repeats for a loop of Beam element 308 comprises a value of 0;
“Mode=“Secondary””, which indicates the mode of Beam element 308 is a secondary mode;
“Poly=“2””, which indicates a poly value of Beam element 308 comprises a value of 0;

“Trigger=“OneShot””, which is a categorical value that indicates a type of trigger being one a “OneShot” trigger, a StartStop trigger, a Pulsed trigger, and a swap sounds trigger, Beam element 308 being a “OneShot” trigger;
“Step=“0””, which indicates a Step value of Beam element 308 comprises a value of 0;
“FreeWheel=“0””, which indicates a FreeWheel value of Beam element 308 comprises a value of 0;
“Slave=“0””, which indicates Beam element 308 is not a slave to another beam identified as a master beam;
“Master=“0””, which indicates Beam element 308 is not a master over other beams identified as a slave beams;
“Volume=“−140””, which indicates a volume Beam element 308 is adjusted by −140 relative to a master volume of multilayered media file 208;
“TimeShift=“0””, which indicates Beam element 308 is shifted in time by an amount of 0;
“NoCutOff=“0””, which is a Boolean value and indicates Beam element 308 does not use a no cut off feature;
“GroupCount=“0””, which indicates Beam element 308 comprises a group count of 0;
“GroupID=“0””, which indicates Beam element 308 is associated with a group identifier with a value of 0;
“AllowEmbeddedTempo=“1””, which is a Boolean value and indicates Beam element 308 allows an embedded tempo;
“MuteFunc=“0””, which is a Boolean value and indicates Beam element 308 does not use a mute function; and
“DuckFunc=“0””, which is a Boolean value and indicates Beam element 308 does not use a duck function.

Beam element 308 includes a “Regions” element 402. Regions element 402 includes one or more “Region” elements 404, 408, 416.

Region element 404 includes a “Name” attribute with a value of “Ending” that indicates a name of Region 404. Region element 404 includes a “Title” attribute with a value of “Crash” indicating a title of Region element 404. Region element 404 includes an empty “Segments” element 406.

Region element 408 includes a “Name” attribute with a value of “Default” that indicates a name of Region 408. Region element 408 includes a “Title” attribute with a value of “Crash” indicating a title of Region element 408. Region element 408 includes a “Segments” element 410, which comprises “Segment” elements 412 and 414. Attributes of Segment element 412 include:
“File=“Cool Jazz_KitCRASH.mp3”” which indicates a file name of a media file associated with Segment element 412 of Region element 408 of Regions element 402 of Beam element 308 of Beams element 306 of Program element 304 of definition file 208 of multilayered media file 216;
“EndTime=“9530””, which indicates Segment element 412 ends at time 9530;
“LoopEnd=“9530””, which indicates a loop of Segment element 412 ends at time 9530;
   Attributes of Segment element 414 include:
“File=“Cool Jazz_KitCRASH.mp3”” which indicates a file name of a media file associated with Segment element 414 of Region element 408 of Regions element 402 of Beam element 308 of Beams element 306 of Program element 304 of definition file 208 of multilayered media file 216;
“Trans=“1””, which indicates a Trans attribute of Segment element 414 comprises a value of 1;
“EndTime=“9530””, which indicates Segment element 414 ends at time 9530; and
“LoopEnd=“9530””, which indicates a loop of Segment element 414 ends at time 9530.

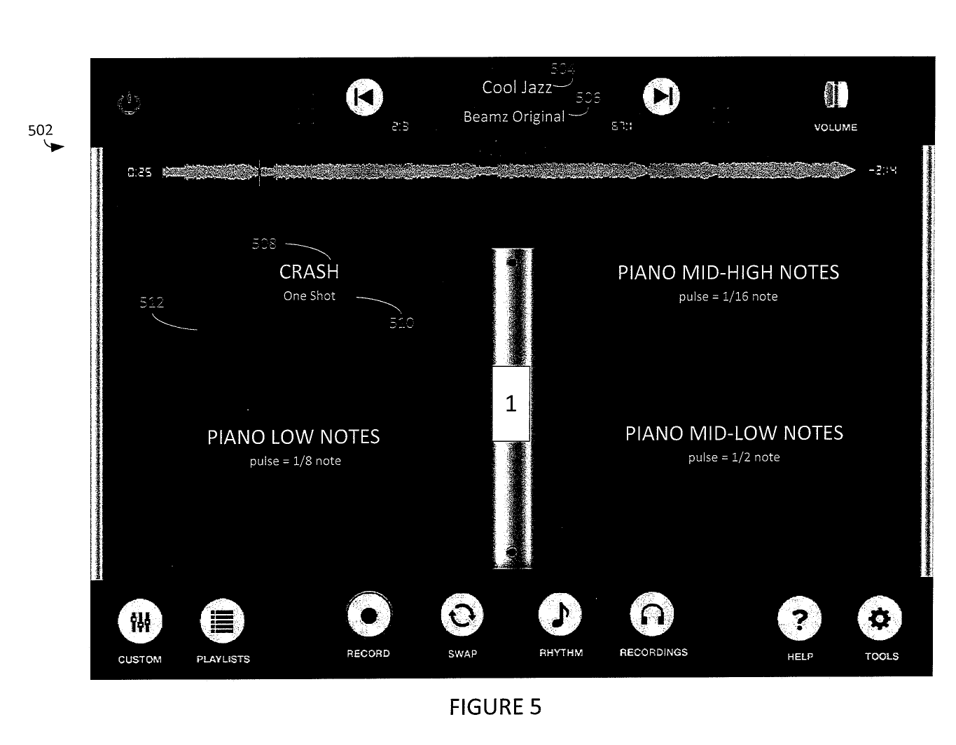

FIG. 5 illustrates a graphical user interface (GUI) in accordance with embodiments of the present disclosure. The embodiment shown in FIG. 5 is for illustration only. Other embodiments could be used without departing from the scope of this disclosure.

GUI 502 includes several user interface (UI) elements to manipulate multilayered media playback. GUI 502 is displayed on touchscreen 202 to allow a user to interact with the UI elements of GUI 502.

Text elements 504 and 506 provide information about current multilayered media file 216. Text element 504 indicates a song name of multilayered media file 216 is “Cool Jazz”, as specified in the Name attribute of Program element 304 of definition file 208 of multilayered media file 216. Text element 506 indicates a name of an artist of multilayered media file 216 is “Beamz Original”, as specified in the Artist attribute of Program element 304 of definition file 208 of multilayered media file 216.

Display of beam 512 on GUI 502 includes text elements 508 and 510. Beam 512 is defined by Beam element 308 of FIGS. 3 and 4. Text element 508 indicates a name of the instrument and layer of media associated with beam 512. Text element 510 indicates additional information about the instrument and layer of media associated with beam 512. As illustrated by text elements 508 and 510, the layer of media associated with beam 512 is an instrument named “Crash” with a description of “One Shot”, as specified in Beam element 308 of Beams element 306 of Program element 304 of definition file 208 of multilayered media file 216. Beam 512 on GUI 502 is active, as indicated by the display of beam 512 as compared to the other beams of GUI 502, which are displayed as not active.

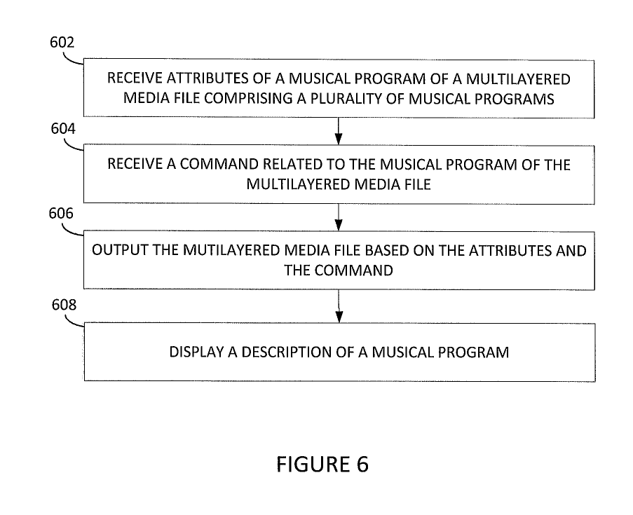

FIG. 6 illustrates a flowchart for playback of multilayered media file 216 according to embodiments of the present disclosure. While the flowchart depicts a series of sequential steps, unless explicitly stated, no inference should be drawn from that sequence regarding specific order of performance of steps, or portions thereof, serially rather than concurrently or in an overlapping manner, or performance the steps depicted exclusively without the occurrence of intervening or intermediate steps. The process depicted in the example is implemented by any suitably configured electronic device, such as electronic device 102 of FIG. 1.

At step 602, processing unit 140 receives attributes of a musical program of multilayered media file 216, which comprises a plurality of musical programs. The attributes of the musical program of the multilayered media file comprise one or more values each related to one of: a description of the musical program, a pulse rate of the musical program, a pulse delay of the musical program, a trigger of the musical program, a volume of the musical program, and a time shift of the musical program. The values related to the trigger comprise an indication of a type of the trigger and a debounce value of the trigger. The type of the trigger comprises one of a one shot trigger, a start stop trigger, a pulsed trigger, and a swap sounds trigger. The value related to the volume of the musical program is relative to a volume of the multilayered media file. The value related to the time shift of the musical program is a time shift relative to playback of the multilayered media file.

At step 604, processing unit 140 receives a command related to a musical program of multilayered media file 216. The command is a trigger that controls the musical program of the multilayered media file.

At step 606, processing unit 140 outputs a multilayered media file 216 based on one or more attributes and commands. Each of the musical programs of multilayered media file 216 comprises a subset of a predetermined musical composition, and each of the musical programs is correlated to each other. Each of the musical programs of multilayered media file 216 comprises sound elements configured to generate sympathetic musical sounds.

At step 608, processing unit 140 displays a description of a musical program of multilayered media file 216. The description is defined in definition file 208 of multilayered media file 216.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of operating a device for playback of a multilayered media file, the method comprising:
receiving one or more attributes of a musical program of a multilayered media file comprising a plurality of musical programs;
receiving a command related to the musical program of the multilayered media file; and
outputting the multilayered media file based on the attributes and the command.

2. The method of claim 1, wherein:
the command is a trigger that controls the musical program of the multilayered media file.

3. The method of claim 1, wherein:
the attributes of the musical program of the multilayered media file comprise one or more values each related to one of: a description of the musical program, a pulse rate of the musical program, a pulse delay of the musical program, a trigger of the musical program, a volume of the musical program, and a time shift of the musical program.

4. The method of claim 3, wherein:
the values related to the trigger comprise an indication of a type of the trigger and a debounce value of the trigger.

5. The method of claim 4, wherein:
the type of the trigger comprises one of a one shot trigger, a start stop trigger, a pulsed trigger, and a swap sounds trigger.

6. The method of claim 3, wherein:
the value related to the volume of the musical program is relative to a volume of the multilayered media file.

7. The method of claim 3, wherein:
the value related to the time shift of the musical program is relative to playback of the multilayered media file.

8. The method of claim 1, wherein:
each of the musical programs comprises a subset of a predetermined musical composition, and
each of the musical programs is correlated to each other.

9. The method of claim 1, wherein:
each of the musical programs comprises sound elements configured to generate sympathetic musical sounds.

10. The method of claim 3, further comprising:
displaying the description of the musical program by the device.

11. An apparatus configured for playback of a multilayered media file, the apparatus comprising:
a speaker;
a display; and
one or more processors configured to:
receive one or more attributes of a musical program of a multilayered media file comprising a plurality of musical programs,
receive a command related to the musical program of the multilayered media file, and
use the speaker and the display to output the multilayered media file based on the attributes and the command.

12. The apparatus of claim 11, wherein:
the command is a trigger that controls the musical program of the multilayered media file.

13. The apparatus of claim 11, wherein:
the attributes of the musical program of the multilayered media file comprise one or more values each related to one of: a description of the musical program, a pulse rate of the musical program, a pulse delay of the musical program, a trigger of the musical program, a volume of the musical program, and a time shift of the musical program.

14. The apparatus of claim 13, wherein:
the values related to the trigger comprise an indication of a type of the trigger and a debounce value of the trigger.

15. The apparatus of claim 14, wherein:
the type of the trigger comprises one of a one shot trigger, a start stop trigger, a pulsed trigger, and a swap sounds trigger.

16. The apparatus of claim 13, wherein:
the value related to the volume of the musical program is relative to a volume of the multilayered media file.

17. The apparatus of claim 13, wherein:
the value related to the time shift of the musical program is relative to playback of the multilayered media file.

18. The apparatus of claim 11, wherein:
each of the musical programs comprises a subset of a predetermined musical composition, and
each of the musical programs is correlated to each other.

19. The apparatus of claim 11, wherein:
each of the musical programs comprises sound elements configured to generate sympathetic musical sounds.

20. The apparatus of claim 13, wherein the one or more processors are further configured to:
cause the display to display the description of the musical program.

21. A computer readable medium configured to store program instructions for playback of a multilayered media file, the program instructions configured to cause one or more processors to:
receive one or more attributes of a musical program of a multilayered media file comprising a plurality of musical programs;
receive a command related to the musical program of the multilayered media file; and
cause the speaker and the display to output the multilayered media file based on the attributes and the command.

22. The computer readable medium of claim 21, wherein:
the command is a trigger that controls the musical program of the multilayered media file.

23. The computer readable medium of claim 21, wherein:
the attributes of the musical program of the multilayered media file comprise one or more values each related to one of: a description of the musical program, a pulse rate of the musical program, a pulse delay of the musical program, a trigger of the musical program, a volume of the musical program, and a time shift of the musical program.

24. The computer readable medium of claim 23, wherein:
the values related to the trigger comprise an indication of a type of the trigger and a debounce value of the trigger.

25. The computer readable medium of claim 24, wherein:
the type of the trigger comprises one of a one shot trigger, a start stop trigger, a pulsed trigger, and a swap sounds trigger.

26. The computer readable medium of claim 23, wherein:
the value related to the volume of the musical program is relative to a volume of the multilayered media file.

27. The computer readable medium of claim 23, wherein:
the value related to the time shift of the musical program is relative to playback of the multilayered media file.

28. The computer readable medium of claim 21, wherein:
each of the musical programs comprises a subset of a predetermined musical composition, and
each of the musical programs is correlated to each other.

29. The computer readable medium of claim 21, wherein:
each of the musical programs comprises sound elements configured to generate sympathetic musical sounds.

30. The computer readable medium of claim 23, wherein the one or more processors are further configured to:
cause the display to display the description of the musical program.
